(19) United States
(12) Patent Application Publication
(10) Pub. No.: US 2011/0318146 A1
(43) Pub. Date: Dec. 29, 2011

(54) REMOVING BAYS OF A TEST SYSTEM

(76) Inventor: Christopher James Bruno, Hudson, MA (US)

(21) Appl. No.: 12/826,083

(22) Filed: Jun. 29, 2010

(51) Int. Cl. B65G 1/04

(52) U.S. Cl. 414/277

(57) ABSTRACT

A system for testing devices includes a rack including bays configured to receive totes containing devices to be tested, where each bay includes a front that faces a robot, the robot is for moving the totes into and out of the bays, and each bay includes a back that is behind the first rack relative to the robot. At least one of the bays is configured for removal from the back of the rack without substantially interrupting operation of the system.

### TECHNICAL FIELD

This patent application relates generally to removing bays of a test system.

### BACKGROUND

A robotic test system may include a rack having multiple slots. The slots may be arranged vertically and horizontally. Each slot may house a bay. A robot is used to move one or more devices under test into, and out of, each bay. A bay typically includes electronics, power lines, and other circuitry that is used to test a device in the bay. Bays, however, may require servicing. It is known to service a bay in a test rack without stopping a testing process. However, in order to remove a bay for servicing, testing is stopped. Stopping a testing process in order to remove a bay for servicing can dramatically affect the amount of time it takes to perform testing.

### SUMMARY

This patent application describes removing bays of a test system, e.g., for servicing.

More generally, described herein is a system for testing devices. The system comprises a rack comprising bays configured to receive totes containing devices to be tested, where each bay comprises a front that faces a robot, the robot is for moving the totes into and out of the bays, and each bay comprises a back that is behind the first rack relative to the robot. At least one of the bays is configured for removal from the back of the rack without substantially interrupting operation of the system. The system may include one or more of the following features, either alone or in combination.

The robot may be configured to maintain operation while the at least one of the bays is removed for servicing. The rack is a first rack, the bays are first bays, the totes are first totes, and the robot is a first robot. The system may further comprise a second rack comprising second bays configured to receive second totes containing devices to be tested, where each second bay comprises a front that faces a second robot, the second robot may be for moving the second totes into and out of the second bays, and each second bay comprises a back that is behind the second rack relative to the second robot. The second robot may be configured to run along a track that is about parallel to the front of the second rack. A distance between the first rack and the second rack is sufficient to accommodate removal of the at least one of the bays of the first rack for servicing.

The system may further comprise a first soak structure configured to receive the first totes. The first robot may be for moving the first totes into and out of the first soak structure, the first soak structure may be in series with the first rack relative to motion of the first robot, and the first soak structure may have a width that is measured at about a perpendicular to a direction of motion of the first robot. The system may comprise a second rack comprising second bays configured to receive second totes containing devices to be tested. Each second bay may comprise a front that faces a second robot, the second robot may be for moving the second totes into and out of the second bays, and each second bay may comprise a back that is behind the second rack relative to the second robot. The second rack may be about in parallel with the first rack relative to motion of the second robot. A service area, through which the at least one of the bays of the first rack is accessible, may be between the first rack and the second rack. The service area may have a width that is measured at about a perpendicular to a direction of motion of the second robot and that is greater than or equal to the width of the first soak structure.

The system may comprise a second soak structure configured to receive the second totes. The second robot may be for moving the second totes into and out of the second soak structure. The second soak structure may be in series with the second rack relative to motion of the second robot. The system may comprise a third soak structure configured to receive the second totes. The second robot may be for moving the second totes into and out of the third soak structure. The third soak structure may be in parallel with, and between, the first soak structure and the second soak structure. The service area may be in series with the third soak structure relative to motion of the second robot. The service area may be at least four feet in width; however, other widths may be used.

Each second bay may comprise a front that faces a second robot, the second robot may be for moving the second totes into and out of the second bays, and each second bay may comprise a back that is behind the second rack relative to the second robot. The second rack may be about in parallel with the first rack relative to motion of the second robot. The system may comprise a third rack comprising third bays configured to receive third totes containing devices to be tested. Each third bay may comprise a front that faces the first robot, the first robot may be for moving the third totes into and out of the third bays, and each third bay may comprise a back that is behind the third rack relative to the first robot. The third rack may be about in series with the first rack relative to motion of the first robot. The system may comprise fourth rack comprising fourth bays configured to receive fourth totes containing devices to be tested. Each fourth bay may comprise a front that faces the second robot, the second robot may be for moving the fourth totes into and out of the fourth bays, and each fourth bay may comprise a back that is behind the fourth rack relative to the second robot. The fourth rack may be about in series with the second rack relative to motion of the second robot. The system may also comprise a first soak structure configured to receive the first totes. The first robot may be for moving the first totes into and out of the first soak structure, and the first soak structure may be in series with the first rack relative to motion of the first robot. A second soak structure may be configured to receive the second totes. The second robot may before moving the second totes into and out of the second soak structure, and the second soak structure may be in series with the second rack relative to motion of the second robot. At least one of the first soak structure and the second soak structure may comprise an ambient soak structure. An entirety of the at least one of the bays may be configured for removal.

Also described herein is a system for testing devices. The system comprises a rack comprising bays configured to receive totes that hold devices to be tested; a robot configured to move the totes into, and out of, a front of the rack; and a service area behind the rack relative to the robot. The service area has a size sufficient to accommodate removal of the bays from a back of the rack while the robot is operational. The system may include one or more of the following features, either alone or in combination.

The rack is a first rack, the totes are first totes, and the robot is a first robot. The system may also comprise a second rack comprising bays configured to receive second totes that hold devices to be tested, and a second robot configured to move the second totes into, and out of, a front of the second rack. The service area may be between the first rack and the second rack. A soak structure may be in series with the service area relative to a path of motion of the second robot. The second robot may be configured to move totes into, and out of, the soak structure prior to moving totes into, and out of, the front of the second rack. The soak structure may have a width that is measured about perpendicular to the path of motion of the second robot. The service area may have a width that is greater than equal to a width of the soak structure. The service area may have a width that is measured about perpendicular to a path of motion of the robot, where the width is at least four feet.

Also described herein is a rack configured for use in a test system. The rack comprises bays configured to receive, from a robot serving the rack, totes containing devices to be tested. Each of the bays may be configured to receive a tote from a front of the rack, and each of the bays may be configured for removal from a back of the rack while the robot serves the rack. The rack may include one or more of the following features, either alone or in combination.

The rack may further comprise a first member having notches for slidably engaging legs of corresponding bays, a second member having holes that align to holes in tabs of corresponding bays, connections in the first member for providing power to the bays, and/or connections in the first member for connection to Ethernet, a calibration line, and a pneumatic air line. Each of the bays may be configured to receive one tote, where the one tote holds multiple devices to be tested. An entirety of each of the bays may be configured for removal from a back of the rack while the robot serves the rack. A portion of each of the bays may be configured for removal from a back of the rack while the robot serves the rack.

The devices being tested may comprise storage cells, such as batteries. At least some of the bays may be self-contained. A robot at the back of a rack may be configured to remove one or more bays from the rack for servicing. This robot may be a different robot than the one serving the front of the rack.

Any two or more of the features described in this patent application, including this summary section, may be combined to form embodiments not specifically described in this patent application.

The details of one or more examples are set forth in the accompanying drawings and the description below. Further features, aspects, and advantages will become apparent from the description, the drawings, and the claims.

### DESCRIPTION OF THE DRAWINGS

FIG. 1 is a perspective view of a front of a rack, such as a formation and test rack, used in the test system described herein.

FIG. 2 is a perspective view of a back of the rack, which shows slots defined by the test rack and a bay partially inside one of the slots.

FIG. 3 is a perspective view of a bay and a rack, such as those shown in FIGS. 1 and 2, which shows how the bay mates to the rack.

FIG. 4A is a perspective view of a cylindrical tote, which fits into a bay in a rack; and

FIG. 4B is a perspective view of a pouch/prismatic tote, which fits into a bay in a rack.

FIG. 5 is a perspective view of a robot used to serve racks in the test system.

FIG. 6 is a perspective view of a storage cell (e.g., battery) test system, which includes hot soak, ambient soak, and formation and test stages arranged in series.

FIG. 7 is a top view of the test system shown in FIG. 6.

FIG. 8 is a top view of a storage cell (e.g., battery) test system, which includes a hot soak stage arranged in parallel with serially-arranged ambient soak and formation and test stages.

FIG. 9 is a perspective view of the test system shown in FIG. 8.

FIG. 10 is a side view of a tote on an arm of a robot, such as that of FIG. 5.

FIG. 11 is a top view of a storage cell (e.g., battery) test system, which includes hot soak, ambient soak, and formation and test stages arranged in series.

### DETAILED DESCRIPTION

Described herein is a system for testing devices, including, but not limited to, storage cells, such as lithium ion batteries. The system includes a rack configured to receive totes that hold devices to be tested; a robot configured to move the totes into, and out of, a front of the rack; and a service area behind the rack relative to the robot. The service area has a size sufficient to accommodate removal of the totes from a back of the rack while the robot is operational (e.g., while the robot continues to insert totes into, and remove totes from, the bays). Thus, individual bays can be removed (that is, the entire bay may be removed, or portions thereof may be removed), serviced, and replaced in real-time without interrupting the robot or at least without stopping or shutting-down the robot (the robot may need to be programmed not to access the bay being serviced, which may result in some interruption). As a result, delays in testing resulting from bay servicing can be reduced. The same is true for other components of the system. That is, any other repairs, updates, and/or services to the rack and its components may be made from the service area at the back of the rack.

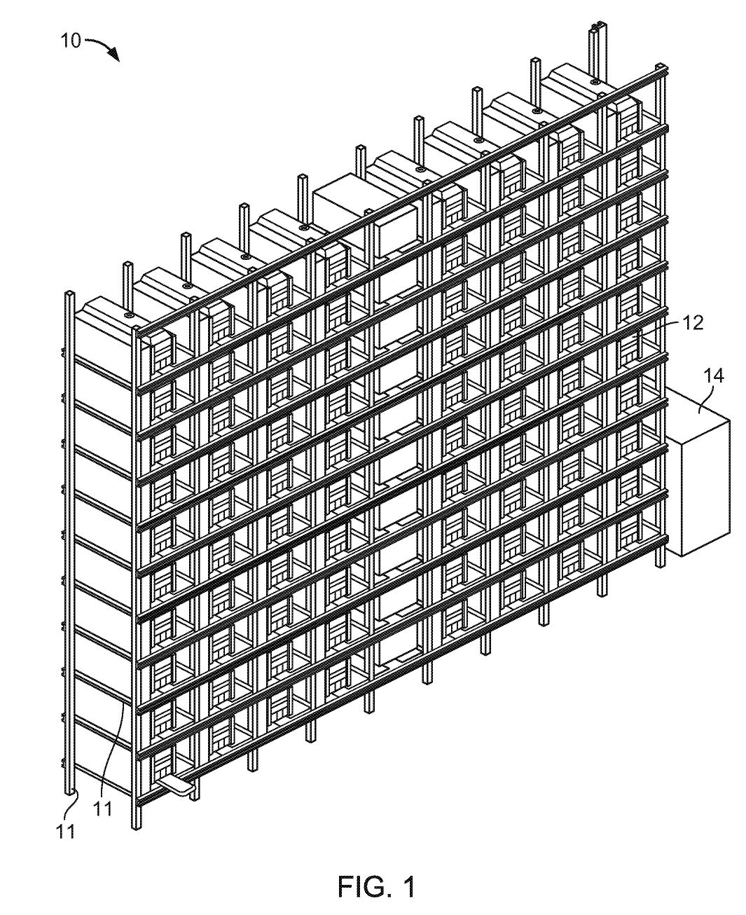

FIG. 1 shows a structure of a rack 10 that may be included in an implementation of the test system. Rack 10 may be formed from structural members 11, such as beams or the like, that are configured to define slots that house bays 12. The bays may be arranged in horizontal rows and vertical columns, as shown in FIG. 1. FIG. 1 also shows a power distribution cabinet 14 for providing power to bays in rack 12.

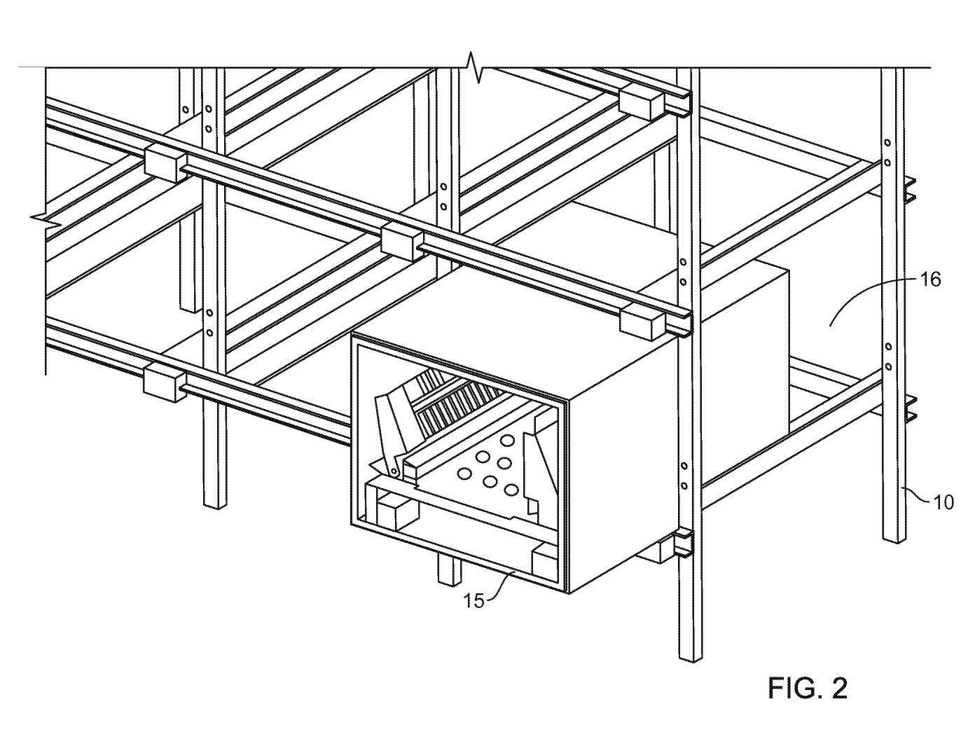

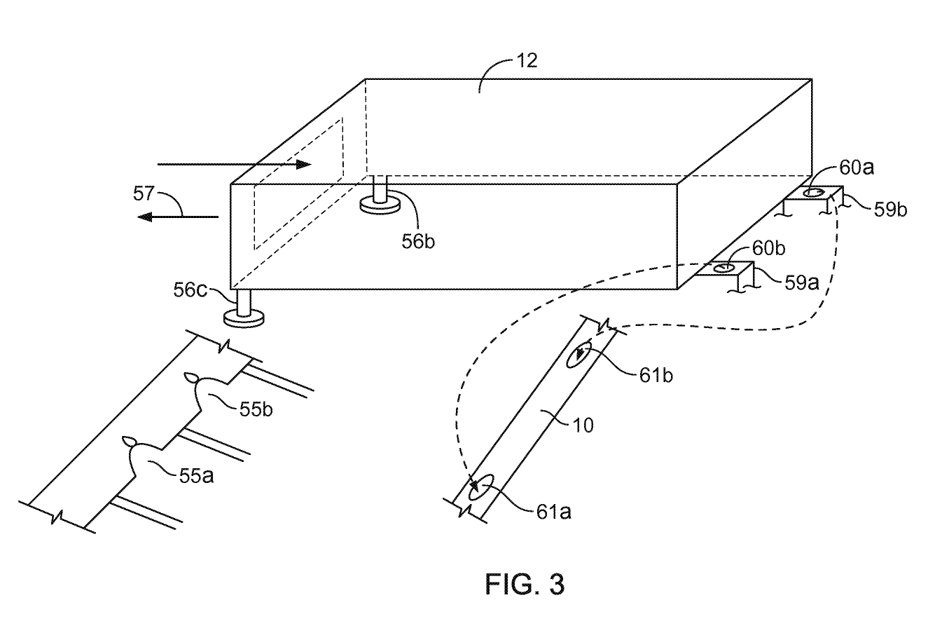

FIG. 2 shows an example of a bay 15 in relation to a slot 16 of rack 10. Each bay, such as bay 16, may be manually incorporated into its corresponding slot as shown, and held there by bolts or other fastener(s) (not shown). An example of a mating between one type of bay and one type of slot is described below with respect to FIG. 3. In this implementation, each bay is self-contained, since it contains all of the electronics necessary for testing batteries in a tote are contained in the bay, and the bay (including the electronics) is modular in the sense that it can be removed without affecting other bays in the system. In other implementations not all of the bays need be self-contained.

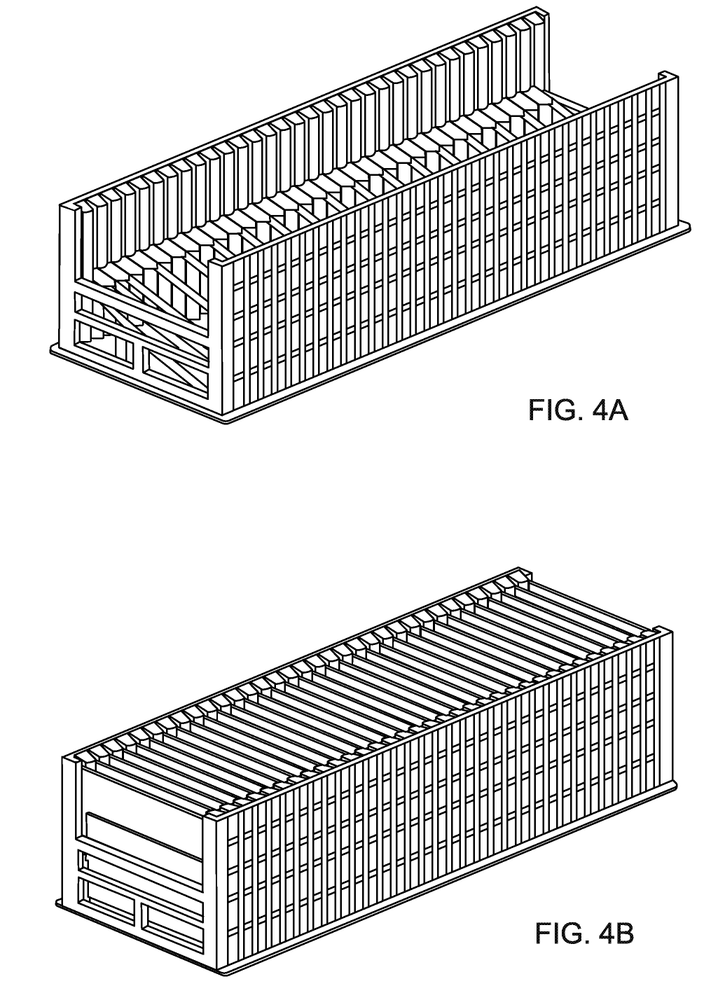

Each bay may be configured to hold a tote. In this context, a tote is an apparatus for holding devices (e.g., batteries) to be tested by the system. In one implementation, each tote is configured to hold multiple batteries for test. For example, in the totes of FIGS. 4A and 4B, batteries may be arranged side-by-side. In other implementations, there may be only one battery per tote. A tote may include electrical and mechanical connections (not shown) used to pass electrical signals, fluid and/or air between a corresponding bay and batteries in the tote. As described below, bays may be configured to pass electrical signals between a central computer or other test equipment (not shown) and corresponding totes. The bays may also be configured to pass fluid and/or air between the rack and the totes.

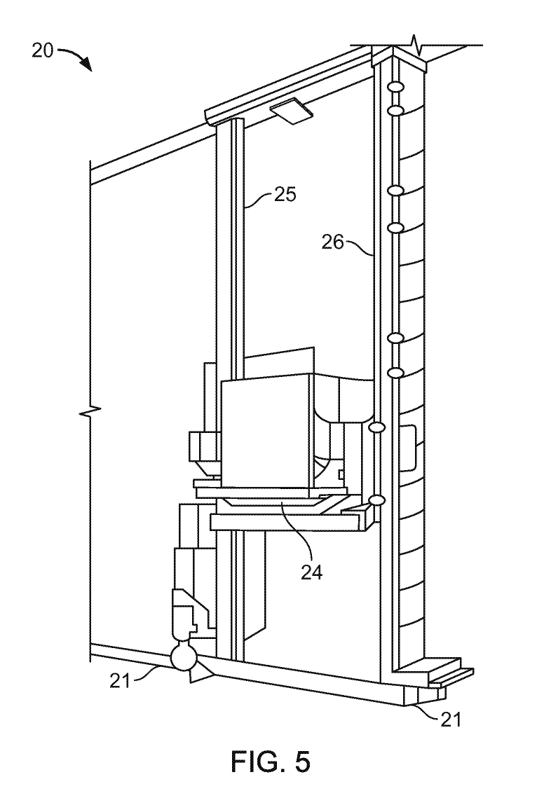

Rack 10 is served by a robot, also called a “crane”. An example of a robot 20 used to serve rack 10 is shown in FIG. 5. In the example of FIG. 5, robot 20 includes wheels 21 that enable it to move along a track. For example, robot 20 may be configured to move along a track that runs substantially parallel to the front (see, e.g., FIG. 1) of rack 10. In this context, the “front” of a rack is the side of the rack from which the robot can remove totes, and into which the robot can insert totes. To this end, robot 20 includes a mechanism 24 for removing totes from, and inserting totes into, corresponding bays. That mechanism may include an arm (not shown) that supports a tote, that projects or telescopes outwardly from the robot to a bay in which the tote is to be inserted, and that retracts leaving the tote in the bay.

Mechanism 24 moves vertically along tracks 25 and 26, which are part of the robot. This movement allows mechanism 24 to access bays at the upper and lower levels various racks. Robotic configurations other than those shown in FIG. 5 may be used to achieve the same functionality and range of motion as robot 20.

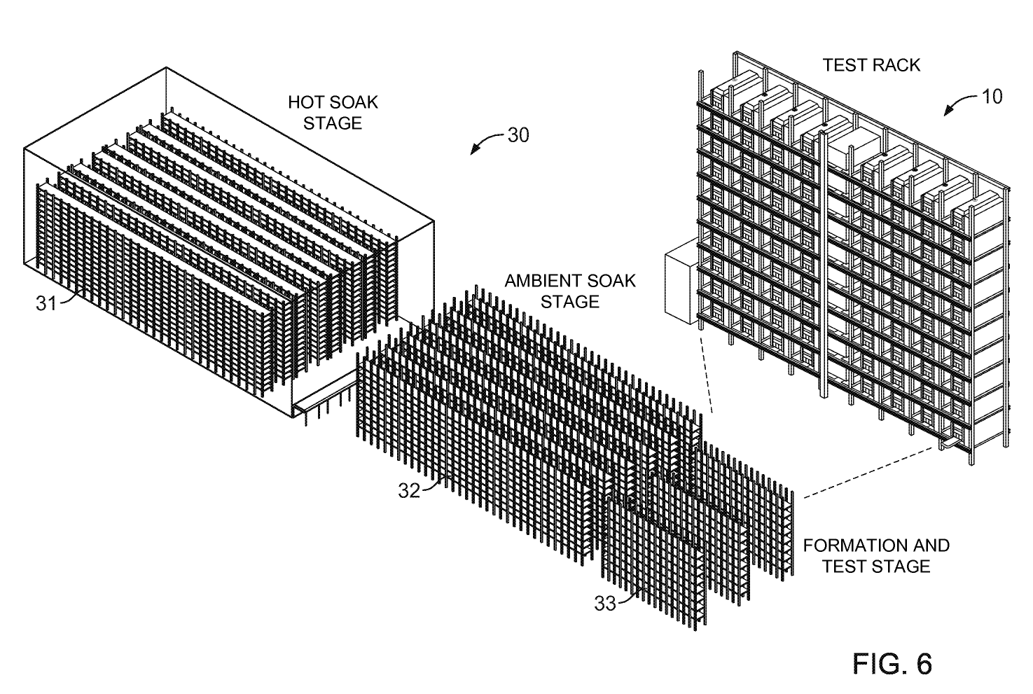

FIG. 6 shows a configuration of a test system 30 that includes racks, bays, totes, and robots of the type described above. Test system 30 includes several (in this example, three) stages, through which storage cells (in this example, batteries) are formed and tested. These stages include, but are not limited to, a hot soak stage 31, and ambient soak stage 32, and a formation and test stage 33 (or simply, “test stage”).

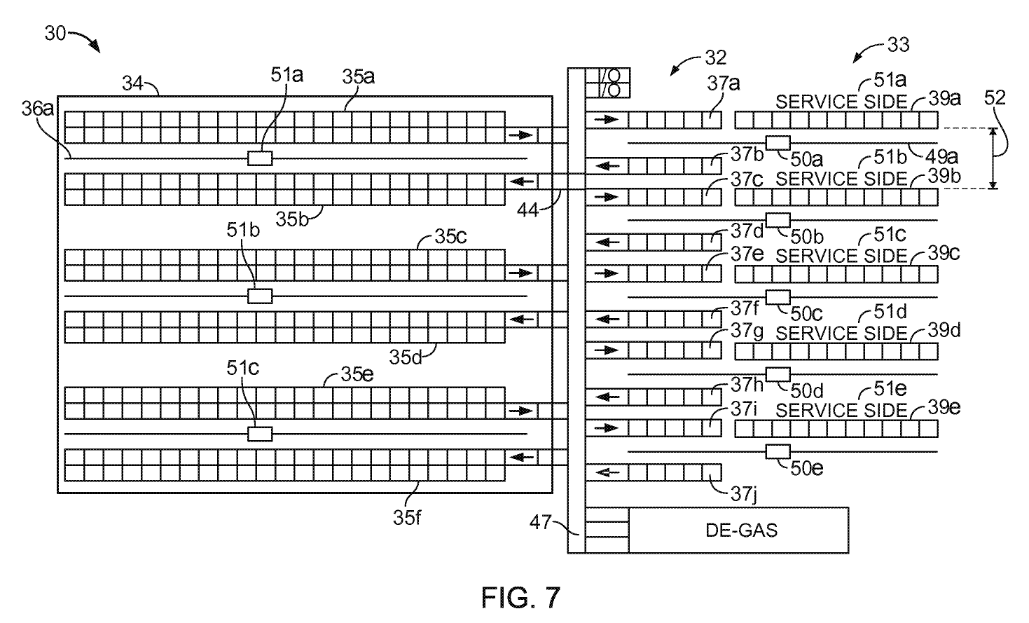

Referring to FIG. 7, hot soak stage 31 takes place in a “hot” room 34, in which the temperature is higher than ambient/room temperature (e.g., 25° C.). Hot room 34 includes “hot” racks 35a to 35f, which may have configurations that are similar to, or identical to, that of rack 10 (FIG. 1). The hot racks are served by robots, such as robot 20 (FIG. 5). More specifically, each hot rack includes bays, such as those described above, whose fronts face a robot. The robot is configured to move along tracks, such track 36a, and to move totes containing batteries into, and out of, bays in the hot racks. In hot room 34, a single robot serves two adjacent hot racks. That is, the fronts of adjacent hot racks (the sides of the hot racks that can accept totes into bays) face a robot so that the robot can access bays in either adjacent hot rack. So, as shown in FIG. 7, the front of hot rack 35a faces a robot 51a on track 36a and the front of hot rack 35b faces that same robot. To enable this operation, robots in the hot room are configured to access bays on both sides of the robot. For example, such a robot may swivel relative to its track so that its arm can access a bay on either side of the robot. Alternatively, the robot may include multiple arms, at least one of which faces each rack to enable totes to be inserted into, or removed from, corresponding bays.

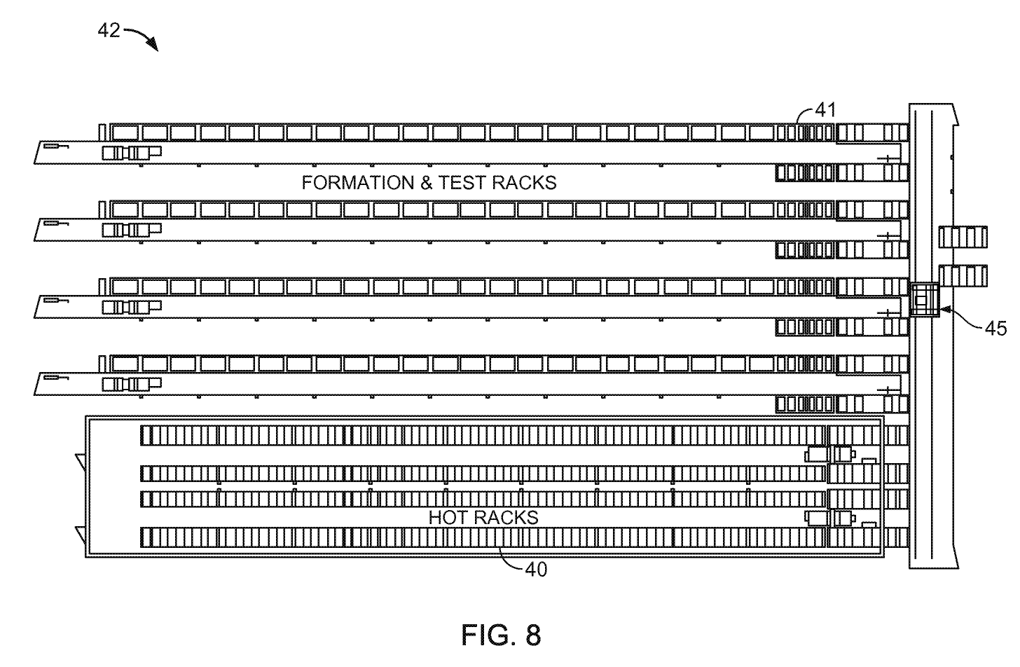

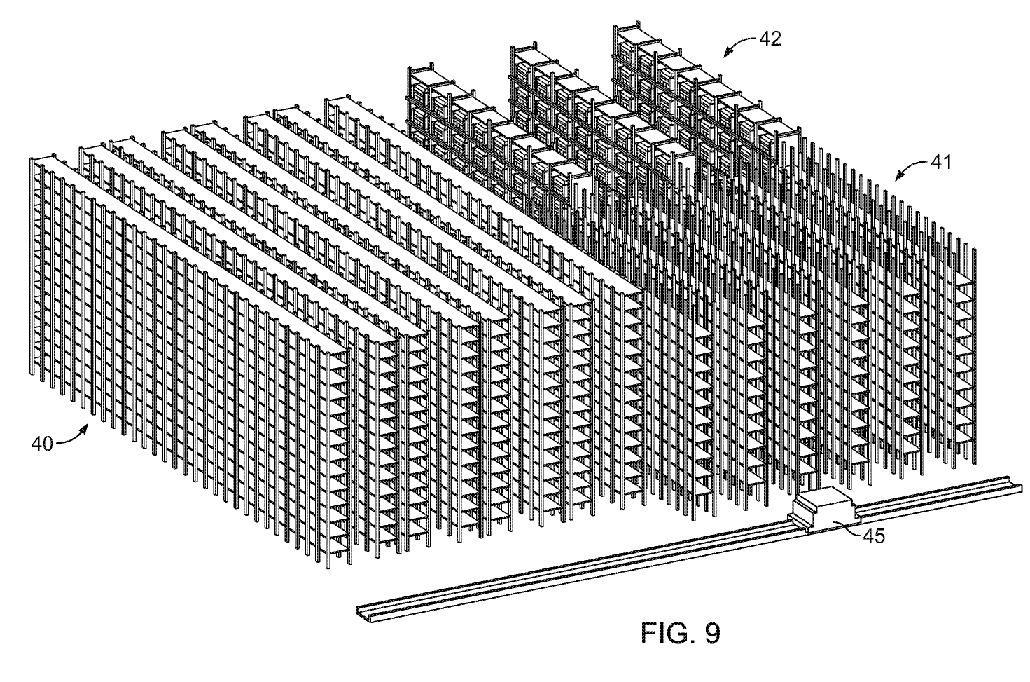

As shown in FIG. 7, in hot room 34, hot racks 35a to 35f are arranged substantially in parallel, although this is not a requirement of the test system. In the arrangement shown in FIG. 7, hot racks 35a to 35f are arranged in series relative to ambient racks 37a to 37j and formation and test rack (or simply “test racks”) 39a to 39e. In other implementations, such as that shown in FIGS. 8 and 9, hot racks 40 are adjacent to ambient racks 41 and test racks 42.

Referring to FIG. 7, ambient racks 37a to 37j are part of ambient soak stage 32, which may take place in a room maintained at ambient temperature (e.g., 25° C.). One purpose of the ambient soak stage is to allow batteries in the totes to reach ambient temperature prior to formation and testing.

In operation, a robot moves a tote from a hot rack, such as hot rack 35b, to a shuttle or transfer vehicle 44 (or simply “transfer vehicle”). In the implementation of FIGS. 6 and 7, transfer vehicle 44 is between the hot racks and the ambient racks. In the implementation of FIGS. 8 and 9, transfer vehicle 45 is adjacent to the hot racks and to the ambient racks. Different robots 50a to 50e serve ambient racks (and also the test racks—described below) than serve the hot racks. In the implementation of FIG. 7, a robot (e.g., 51a) in hot room 34 removes a tote from a hot rack (e.g., 35b) and transfers that tote to transfer vehicle 44. Transfer vehicle 44 moves along track 47 to a location corresponding to a robot in the ambient soak stage. A robot (e.g., 50a) in the ambient soak stage, retrieves the tote from transfer vehicle 44, and transports the tote to a bay in an ambient rack (e.g., 37b).

Ambient racks 37a to 37j may have configurations that are similar to, or identical to, that of rack 10 (FIG. 1). Each ambient rack includes bays, such as those described above, whose fronts face a corresponding robot. The robot is configured to move along a track, such track 49a, and to move totes containing batteries into, and out of, bays in the ambient racks. In the ambient soak stage, as in the hot soak stage, a single robot serves two adjacent ambient racks. That is, the fronts of adjacent ambient racks face the robot so that the robot can access bays in either adjacent ambient rack. So, as shown in FIG. 7, the front of ambient rack 37a faces a robot 50a on track 49a and the front of ambient rack 37b faces that same robot. To enable this operation, the robots in the ambient soak stage are configured to access bays on both sides of the robot. For example, such a robot may swivel relative to its track (i.e., the track the robot is on), so that its arm can access a bay on either side of the robot. Alternatively, the robot may include multiple arms, at least one of which faces each rack to enable totes to be inserted into, or removed from, corresponding bays.

Following the ambient soak stage, a robot, such as robot 50a, retrieves a tote from an ambient rack (e.g., ambient rack 37a), and moves along track 49a to test stage 33. The test stage includes test racks 39a to 39e. The test racks may have configurations that are similar to, or identical to, that of rack 10 (FIGS. 1 and 6). Each test rack includes bays, such as those described above, that face a corresponding robot. The same robot (e.g., robots 50a to 50e) may serve the ambient soak stage and the test stage. To this end, a track for each such robot runs through both the ambient and test stages. Each robot is configured to move along the track, such as track 49a, and to move totes containing batteries into, and out of, bays in the test racks. However, in the test stage, unlike in the ambient and hot soak stages, a single robot serves only one test rack.

More specifically, as shown in FIG. 7, each robot faces the front of a corresponding rack, thereby enabling the robot to move totes into and out of bays in the corresponding rack. For example, robot 50a faces the front of rack 39a, thereby allowing robot to move totes into and out of bays in rack 39a. The area behind each robot (e.g., areas 51a to 51e) does not include another rack. Rather, each area 51a to 51e is left vacant to act as a service area for corresponding racks 39a to 39e. In this regard, the test racks, and bays therein, are configured to allow bays to be removed from behind, i.e., from the back (service side) of each test rack—the side of the test rack that does not face the robot. This enables the bays to be removed, e.g., for servicing, without substantially interrupting operation of the robot serving the front of the test rack. That is, the robot may maintain operation (e.g., moving totes into and out of bays at the front of a rack), while a technician in the service area removes a bay from the back of the rack.

A service area is sufficiently large to accommodate one or more technicians to allow removal of the bay(s) from behind a rack. A distance 52 between test racks (e.g., test racks 39a and 39b) defines a dimension of a service area. The space between racks accommodates a robot and track, in addition to a service area. Each service area should be sufficiently large to accommodate removal of least one, and potentially all, of the bays of a corresponding rack from behind. In one implementation, the distance between racks is about four feet (which is measured at about perpendicular to a path of motion of a corresponding robot). It is noted that the service area is not limited to the dimensions described herein. Any area sufficient to accommodate a technician and tools used to remove bay(s) from a rack may act as the service area. For example, the service area may have a width that is greater than, or equal to, a width of an ambient rack (e.g., 37d) in series with the service area.

Referring to FIGS. 8 and 9, in the alternative configuration for the battery test system, hot racks 40 are substantially parallel to each other, as are ambient racks 41 and test racks 42. However, in this configuration, hot racks 40 are substantially parallel to test racks 42 and ambient racks 41. This is in contrast to the configuration of FIG. 7, in which the hot racks are in series with the ambient racks, which are in series with the test racks. In the configuration of FIG. 8, test racks 42 remain in series with the ambient racks 41. The configuration of the robots servicing the ambient racks and the test racks in FIG. 8 may be the same as (or substantially the same as) the configuration of the robots of FIG. 7. Accordingly, the operation of the system in the ambient soak stage and test stage is the same for the system configuration shown in FIGS. 6 and 7. Likewise, the service areas are similar.

FIG. 3 shows an example of an interface between a bay 12 and a test rack 10. The interface between the ambient racks and bays and/or hot racks and bays may be the same as, or different than, the interface shown in FIG. 3. In the interface of FIG. 3, test rack 10 includes notches 55a, 55b that mate to corresponding legs 56a, 56b protruding from bay 12. That is, the legs 56a, 56b of bay 12 slide into corresponding notches 55a, 55b along the direction of arrow 57. Each bay also includes tabs 59a, 59b with holes 60a, 60b that match to corresponding holes 61a, 61b on test rack 10 when legs 56a, 56b of bay 12 are mated to notches 55a, 55b. Once bay 12 is properly mated to test rack 10, holes 60a, 60b align with holes 61a, 61b. A bolt, screw, or other type of fastener (not shown) may be inserted into the aligned holes to hold the bay in the rack. Other types of fasteners and/or bay/rack attachment configurations may be employed to hold the bay in the rack.

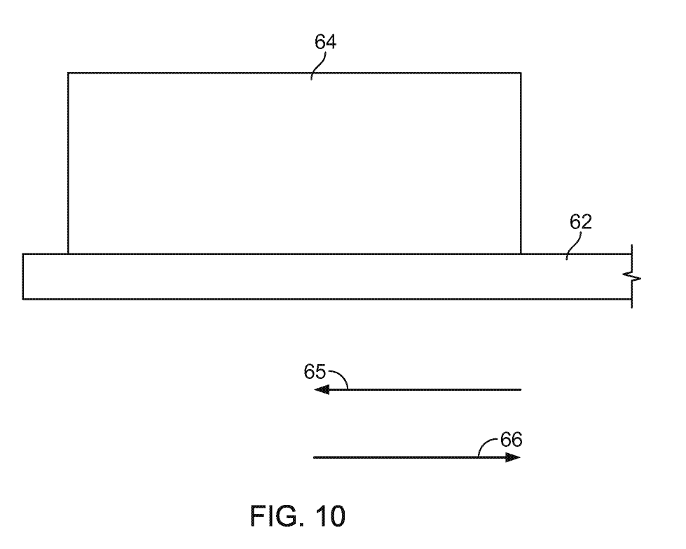

Referring to FIG. 10, each robot may include a generally flat arm 62 that supports a tote 64 from the tote's underside. The arm may project/telescope outwardly from the robot in the direction of arrow 65. This is done in order to slide the tote into place on the bay. Once the tote is in place, arm 62 retracts in the direction of arrow 66, leaving the tote in the bay.

Each bay and test rack may include includes electrical and mechanical mating connections that are used to test batteries (in a tote) in a bay. The connections may include, but are not limited to, a calibration line/bus, a pneumatic air line, an AC (alternating current) line, a DC (direct current) bus, and an Ethernet connection. Each line may be connected/disconnected by a technician inserting a bay into a rack or removing a bay from the rack in the manner described herein or elsewhere.

Testing of batteries in a bay may be performed by a computer (not shown), e.g., by sending signals to and from one or more of the foregoing connections to each bay. The testing may be performed using hardware or a combination of hardware and software. In this regard, any of the testing performed by the system described herein can be implemented, at least in part, via a computer program product, e.g., a computer program tangibly embodied in an information carrier, such as one or more machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the testing can be performed by one or more programmable processors executing one or more computer programs to perform the functions of the calibration process. All or part of the testing can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

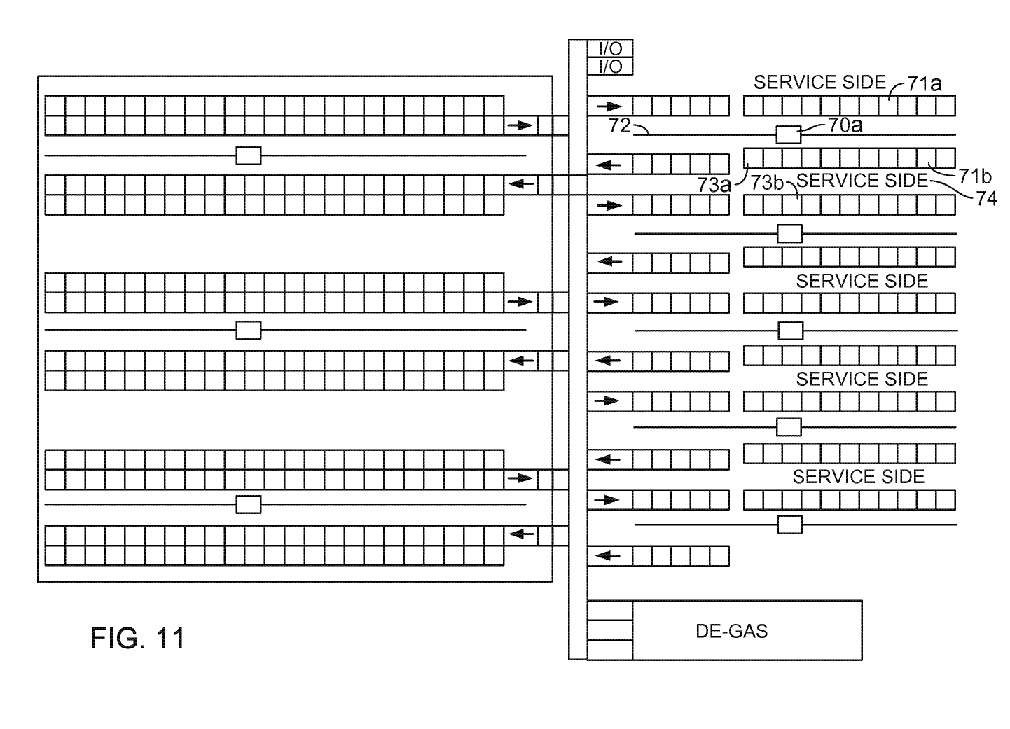

The test system described herein is not limited to the configurations shown in FIGS. 1 to 10. For example, the test system may be configured as shown in FIG. 11. The configuration of FIG. 11 is the same as that of FIG. 7, except that, in FIG. 11, a single robot 70a serves two adjacent test racks. That is, the fronts of adjacent test racks face the robot (as in the ambient and hot soak stages) so that the robot can access bays in either adjacent test racks. So, as shown in FIG. 11, the front of test rack 71a faces robot 70a on track 72 and the front of test rack 71b faces that same robot. To enable this operation, the robots in the test stage are configured to access bays on both sides of the robot. For example, such a robot may swivel relative to its track so that its arm can access a bay on either side of the robot. Alternatively, the robot may include multiple arms, at least one of which faces each rack to enable totes to be inserted into, or removed from, corresponding bays. In this configuration, the distance between backs of adjacent test racks, such as backs 73a and 73b, is sufficient to enable a technician in the service area 74 to remove a bay from the back of a rack, while a robot (e.g., 70a) at the front of the rack remains in operation, as described above. The service area in this configuration may be of the size described above, e.g., four feet of whatever area is sufficient to enable a technician to remove a bay from the back of a rack.

In another implementation, the configuration of the test system may be the same as that of FIG. 8, except that, as in FIG. 11, a single robot serves two adjacent test racks.

In other implementations, each robot may be configured to access the back of a test rack, e.g., via the service area. For example, in FIG. 7 robot 50 may also be configured to access service side 51b of rack 39b. In this case, the robot may be configured to remove the test bays for servicing the manner described herein, e.g., without substantially interrupting testing processes and operation of a robot at the front of the rack. Alternatively, another robot may be provided for removal and replacement of the test bays via the service side.

Although the test system described herein tests electrochemical storage cells (e.g., batteries), that test system may be used to test any type of device. For example, configuration of the robots and test racks alone may be used in a test system that does not involve a hot soak stage and/or an ambient soak stage. That is, the concept of removing bays from the back (or service) side of a rack, while allowing for uninterrupted (or substantially uninterrupted) operation of a robot serving the front of such a rack, may be used in the context of any type of test system that involves racks and robots (e.g., for testing hard drives or solid state devices). Such racks and robots need not be of the type described herein, but rather may be of any type that are usable in any test system.

Furthermore, other stages of the test system described herein, such as the ambient soak stage and the hot soak stage, may be configured in the manner described above to allow removal of bays from the back (or service) side of a rack while allowing for uninterrupted (or substantially uninterrupted) operation of a robot serving the front of such a rack.

Components of different implementations described herein may be combined to form other implementations not specifically set forth above. Components may be left out of the structures described herein, or changed, without adversely affecting their operation. Furthermore, various separate components may be combined into one or more individual components to perform the functions described herein.

An “electrical connection” as used herein may imply a direct physical connection or a connection that includes intervening components but that nevertheless allows electrical signals to flow between connected components. Any “connection” involving electrical circuitry mentioned herein, unless stated otherwise, is an electrical connection and not necessarily a direct physical connection regardless of whether the word “electrical” is used to modify “connection”.

The features described herein may be combined with any one or more of the features described in the following applications: U.S. Provisional Application No. ______, entitled “TEST SYSTEM” (Attorney Docket No. 18523-100P01/2236-US); U.S. patent application No. ______, entitled “ELECTRONIC DETECTION OF SIGNATURES” (Attorney Docket No. 18523-0119001/2234 US); U.S. patent application No. ______, entitled “REMOVING BAYS OF A TEST SYSTEM” (Attorney Docket No. 18523-0120001/2231-US); U.S. patent application No. ______, entitled “CALIBRATING A CHANNEL OFA TEST SYSTEM” (Attorney Docket No. 18523-0121001/2232-US); and U.S. patent application No. ______, entitled “ZERO INSERTION FORCE SCRUBBING CONTACT” (Attorney Docket No. 18523-0122001/2233-US). The contents of the following applications are incorporated herein by reference if set forth herein in full: U.S. Provisional Application No. ______, entitled “TEST SYSTEM” (Attorney Docket No. 18523-100P01/2236-US); U.S. patent application No. ______, entitled “ELECTRONIC DETECTION OF SIGNATURES” (Attorney Docket No. 18523-0119001/2234 US); U.S. Patent Application No. , entitled “REMOVING BAYS OF A TEST SYSTEM” (Attorney Docket No. 18523-0120001/2231-US); U.S. patent application No. ______, entitled “CALIBRATING A CHANNEL OF A TEST SYSTEM” (Attorney Docket No. 18523-0121001/2232-US); and U.S. patent application No. ______, entitled “ZERO INSERTION FORCE SCRUBBING CONTACT” (Attorney Docket No. 18523-0122001/2233-US).

Other embodiments not specifically described herein are also within the scope of the following claims.

What is claimed is:

1. A system for testing devices, comprising:
a rack comprising bays configured to receive totes containing devices to be tested, each bay comprising a front that faces a robot, the robot for moving the totes into and out of the bays, each bay comprising a back that is behind the first rack relative to the robot;
wherein at least one of the bays is configured for removal from the back of the rack without substantially interrupting operation of the system.

2. The system of claim 1, further comprising:
the robot, wherein the robot configured to maintain operation while the at least one of the bays is removed for servicing.

3. The system of claim 1, wherein the rack is a first rack, the bays are first bays, the totes are first totes, and the robot is a first robot, and wherein the system further comprises:
a second rack comprising second bays configured to receive second totes containing devices to be tested, each second bay comprising a front that faces a second robot, the second robot for moving the second totes into and out of the second bays, each second bay comprising a back that is behind the second rack relative to the second robot, the second robot running along a track that is about parallel to the front of the second rack;
wherein a distance between the first rack and the second rack is sufficient to accommodate removal of the at least one of the bays of the first rack for servicing.

4. The system of claim 1, wherein the rack is a first rack, the bays are first bays, the totes are first totes, and the robot is a first robot, and wherein the system further comprises:
a first soak structure configured to receive the first totes, the first robot for moving the first totes into and out of the first soak structure, the first soak structure being in series with the first rack relative to motion of the first robot, the first soak structure having a width that is measured at about a perpendicular to a direction of motion of the first robot; and
a second rack comprising second bays configured to receive second totes containing devices to be tested, each second bay comprising a front that faces a second robot, the second robot for moving the second totes into and out of the second bays, each second bay comprising a back that is behind the second rack relative to the second robot, the second rack being about in parallel with the first rack relative to motion of the second robot;
wherein a service area, through which the at least one of the bays of the first rack is accessible, is between the first rack and the second rack, the service area having a width that is measured at about a perpendicular to a direction of motion of the second robot and that is greater than or equal to the width of the first soak structure.

5. The system of claim 4, further comprising:
a second soak structure configured to receive the second totes, the second robot for moving the second totes into and out of the second soak structure, the second soak structure being in series with the second rack relative to motion of the second robot.

6. The system of claim 5, further comprising:
a third soak structure configured to receive the second totes, the second robot for moving the second totes into and out of the third soak structure, the third soak structure being in parallel with, and between, the first soak structure and the second soak structure.

7. The system of claim 6, wherein the service area is in series with the third soak structure relative to motion of the second robot.

8. The system of claim 7, wherein the service area is at least four feet in width.

9. The system of claim 1, wherein the rack is a first rack, the bays are first bays, the totes are first totes, and the robot is a first robot, and wherein the system further comprises:
a second rack comprising second bays configured to receive second totes containing devices to be tested, each second bay comprising a front that faces a second robot, the second robot for moving the second totes into and out of the second bays, each second bay comprising a back that is behind the second rack relative to the second robot, the second rack being about in parallel with the first rack relative to motion of the second robot;
a third rack comprising third bays configured to receive third totes containing devices to be tested, each third bay comprising a front that faces the first robot, the first robot for moving the third totes into and out of the third bays, each third bay comprising a back that is behind the third rack relative to the first robot, the third rack being about in series with the first rack relative to motion of the first robot; and
a fourth rack comprising fourth bays configured to receive fourth totes containing devices to be tested, each fourth bay comprising a front that faces the second robot, the second robot for moving the fourth totes into and out of the fourth bays, each fourth bay comprising a back that is behind the fourth rack relative to the second robot, the fourth rack being about in series with the second rack relative to motion of the second robot.

10. The system of claim 9, further comprising:
a first soak structure configured to receive the first totes, the first robot for moving the first totes into and out of the first soak structure, the first soak structure being in series with the first rack relative to motion of the first robot; and
a second soak structure configured to receive the second totes, the second robot for moving the second totes into and out of the second soak structure, the second soak structure being in series with the second rack relative to motion of the second robot.

11. The system of claim 10, wherein at least one of the first soak structure and the second soak structure comprises an ambient soak structure.

12. The system of claim 10, wherein an entirety of the at least one of the bays is configured for removal.

13. A system for testing devices, comprising:
a rack comprising bays configured to receive totes that hold devices to be tested;
a robot configured to move the totes into, and out of, a front of the rack; and
a service area behind the rack relative to the robot, the service area having a size sufficient to accommodate removal of the bays from a back of the rack while the robot is operational.

14. The system of claim 13, wherein the rack is a first rack, the totes are first totes, and the robot is a first robot;
wherein the system further comprises:
a second rack comprising bays configured to receive second totes that hold devices to be tested;
a second robot configured to move the second totes into, and out of, a front of the second rack; and
wherein the service area is between the first rack and the second rack.

15. The system of claim 14, further comprising:
a soak structure in series with the service area relative to a path of motion of the second robot, the second robot being configured to move totes into, and out of, the soak structure prior to moving totes into, and out of, the front of the second rack.

16. The system of claim 15, wherein the soak structure has a width that is measured about perpendicular to the path of motion of the second robot; and
wherein the service area has a width that is greater than equal to a width of the soak structure.

17. The system of claim 13, wherein the service area has a width that is measured about perpendicular to a path of motion of the robot, the width being at least four feet.

18. A rack configured for use in a test system, the rack comprising:
bays configured to receive, from a robot serving the rack, totes containing devices to be tested, each of the bays being configured to receive a tote from a front of the rack, each of the bays being configured for removal from a back of the rack while the robot serves the rack.

19. The rack of claim 18, further comprising:
a first member having notches for slidably engaging legs of corresponding bays; and
a second member having holes that align to holes in tabs of corresponding bays.

20. The rack of claim 19, further comprising:
connections in the first member for providing power to the bays; and
connections in the first member for connection to Ethernet, a calibration line, and a pneumatic air line.

21. The rack of claim 18, wherein each of the bays is configured to receive one tote, the one tote holding multiple devices to be tested.

22. The rack of claim 18, wherein an entirety of each of the bays is configured for removal from a back of the rack while the robot serves the rack.

23. The rack of claim 18, wherein a portion of each of the bays is configured for removal from a back of the rack while the robot serves the rack.

24. The system of claim 1, wherein the devices comprise batteries.

25. The system of claim 13, wherein the devices comprise batteries.

26. The rack of claim 18, wherein the devices comprise batteries.

27. The system of claim 1, wherein at least some of the bays are self-contained.

28. The system of claim 13, wherein at least some of the bays are self-contained.

29. The rack of claim 18, wherein at least some of the bays are self-contained.

30. The system of claim 1, further comprising:
a robot configured to remove the at least one of the bays the back of the rack.

31. The system of claim 13, wherein a second robot is configured to remove bays from the back of the rack.
